(19) United States
(12) Patent Application Publication
(10) Pub. No.: US 2025/0305781 A1
(43) Pub. Date: Oct. 2, 2025

(54) HEAT EXCHANGER COMPRISING A FIBER-OPTIC SENSOR FOR DETERMINING A TUBE WALL THICKNESS OF A HEAT-TRANSFER TUBE OF THE HEAT EXCHANGER AND METHOD FOR OPERATING SUCH A HEAT EXCHANGER

(71) Applicant: Schoeller-Bleckmann Nitec GmbH, Ternitz (AT)

(72) Inventors: Zoran DJINOVIC, Wiener Neustadt (AT); Aleksandra GAVRILOVIC-WOHLMUTHER, Pitten (AT); Manuel PROHASKA, Trofaiach (AT)

(73) Assignee: Schoeller-Bleckmann Nitec GmbH, Ternitz (AT)

(21) Appl. No.: 18/868,471

(22) PCT Filed: Mar. 20, 2023
(86) PCT No.: PCT/EP2023/057008

§ 371 Date: Nov. 22, 2024

(30) Foreign Application Priority Data
Jul. 20, 2022 (EP) 22186064.6

(51) Int. Cl. F28F 27/00; G01B 11/06; G01B 11/16

(52) U.S. Cl. CPC F28F 27/00; G01B 11/06; G01B 11/161; G01B 11/18

(57) ABSTRACT

A heat exchanger and method for operating a heat exchanger. The heat exchanger, in particular a high-pressure heat exchanger for urea synthesis, includes multiple heat-transfer tubes for transporting a first fluid in order to transfer heat between the first fluid and a second fluid via the heat-transfer tubes. In order to improve a usability, a fiber-optic sensor is respectively arranged on one or more of the heat-transfer tubes. The fiber-optic sensor is designed to interferometrically ascertain an elastic oscillation, in particular a natural oscillation, of the respective heat-transfer tube during operation of the heat exchanger, in order to determine a tube wall thickness of the respective heat-transfer tube during operation of the heat exchanger.

The invention relates to a heat exchanger, in particular a high-pressure heat exchanger for urea synthesis, comprising multiple heat-transfer tubes for transporting a first fluid in order to transfer heat between the first fluid and a second fluid via the heat-transfer tubes.

The invention furthermore relates to a method for operating a heat exchanger.

It is known from the prior art to use a heat exchanger to exchange thermal energy between a first fluid stream and a second fluid stream. The heat exchanger often comprises multiple heat-transfer tubes for transporting the first fluid stream, in order to transfer heat to a second fluid stream flowing around the heat-transfer tubes, or to absorb heat from said second fluid stream, via the heat-transfer tubes. As part of a urea synthesis, heat exchangers are typically used in which the first or second fluid stream has a high pressure, normally of more than 30 bar, and a high temperature, normally of more than 80° C. The transport of the first fluid stream through the heat-transfer tubes is thereby often associated with an, in particular corrosive and/or erosive. removal of tube wall material of the heat-transfer tubes or a formation of deposits respectively in an interior of the heat-transfer tubes, so that a tube wall thickness of the heat-transfer tubes changes, normally decreases, during operation of the heat exchanger. A diminution of a tube wall integrity of the heat-transfer tubes can be problematic for a safety of operation of the heat exchanger. Therefore, it is typically necessary, based on chronological maintenance intervals, to regularly shut down the heat exchanger and measure tube wall thicknesses of the heat-transfer tubes.

For this purpose, it is typical to insert a measuring probe into the respective heat-transfer tube in a non-operating state of the heat exchanger, in order to determine an inner radius or a tube wall thickness of the heat-transfer tube. Measuring probes are known which comprise an ultrasound sensor, an optical sensor, or an eddy current sensor in order to determine the tube wall thickness.

Particularly in the case of heat exchangers that work with pressures of more than 30 bar and high temperatures of more than 80° C. of the first and/or second fluid stream, a service interruption of this type for determining tube wall thicknesses of the heat-transfer tubes is normally laborious and associated with high costs.

This is addressed by the invention. The object of the invention is to specify a heat exchanger of the type named at the outset which has an optimized usability, in particular an optimized operation.

It is also an object of the invention to specify a method for operating a heat exchanger which enables an optimized use or operation of the heat exchanger.

According to the invention, the object is attained in that, with a heat exchanger of the type named at the outset, a fiber-optic sensor is respectively arranged on one or more of the heat-transfer tubes, wherein the fiber-optic sensor is designed to interferometrically ascertain an elastic oscillation, in particular a natural oscillation, of the respective heat-transfer tube during operation of the beat exchanger. in order to determine a tube wall thickness of the respective heat-transfer tube during operation of the heat exchanger.

The basis of the invention is the idea of improving a usability of heat exchangers, in particular heat exchangers that are designed for a high operating pressure and/or high operating temperature of the first and/or second fluid, in that a tube wall thickness of at least one, preferably multiple heat-transfer tubes of the heat exchanger is determined during operation of the heat exchanger. As a result, an operation, in particular a process management, and/or a maintenance of the heat exchanger can take place depending on the tube wall thickness determined using the fiber-optic sensor. Specifically, it is not necessary to interrupt operation of the heat exchanger in order to determine the tube wall thickness. This can be practicably achieved if, in particular as described, a fiber-optic sensor is respectively arranged on one or more of the heat-transfer tubes. Practicably, a tube wall thickness of a tube wall of the respective heat-transfer tube can be determined using the respective fiber-optic sensor during operation of the heat exchanger in that, using the fiber-optic sensor, an elastic oscillation, in particular a frequency of the clastic oscillation, of the respective heat-transfer tube is interferometrically ascertained. The elastic oscillation is typically an elastic natural oscillation, or the frequency is a natural frequency, of the heat-transfer tube. Expediently, multiple elastic natural oscillations or natural frequences of the respective heat-transfer tube can be ascertained using the fiber-optic sensor in order to determine the tube wall thickness.

Operation of the heat exchanger denotes a state in which the first fluid is conducted through the heat-transfer tubes in order to exchange heat with the second fluid via the heat-transfer tubes. A high operating pressure and a high operating temperature denote an operating pressure of the first fluid and/or of the second fluid of greater than 30 bar and an operating temperature of the first fluid and/or of the second fluid of greater than 80° C., respectively. In particular, the operating pressure is between 30 bar and 200 bar, preferably approximately 180 bar, and/or the operating temperature is between 80° C. and 300° C., preferably approximately 230° C. Normally, the first and/or second fluid has during operation of the heat exchanger an operating pressure of this type and an operating temperature of this type, or the heat exchanger is designed for operation of this type. Accordingly, it is beneficial if the respective fiber-optic sensor is designed for a use or a measurement at a working pressure and a working temperature corresponding to the operating pressure and the operating temperature, respectively. The heat exchanger is preferably a high-pressure heat exchanger. Preferably, the heat exchanger or fiber-optic sensor is designed for the in situ determination and in operando determination of a tube wall thickness of the respective heat-transfer tube, or a tube wall thickness of the respective heat-transfer tube is determined in situ and in operando using the fiber-optic sensor.

It is particularly beneficial if the heat exchanger is a stripper for carrying out a stripping. It is beneficial if the stripper is used for urea synthesis. The stripper can be embodied to synthesize urea by stripping, normally inside of the heat-transfer tubes.

It is advantageous if the fiber-optic sensor comprises an optical measuring fiber, which constitutes an optical measurement section, and an optical reference fiber, which constitutes an optical reference section, wherein the measuring fiber is connected in an oscillation-transferring manner to the heat-transfer tube, preferably wound around the heat-transfer tube, in order to detect an interference signal created with an electromagnetic wave guided along the measurement section and an electromagnetic wave guided along the reference section, using a detector of the fiber-optic sensor. The elastic oscillation of the heat-transfer tube can thus be practicably ascertained. An implementation of the measurement section and of the reference section using optical fibers enables a high robustness of the measurement, as is typically necessary in use conditions of a heat exchanger, in particular a high-pressure heat exchanger. In the present document, in particular hereinafter, the optical measuring fiber and optical reference fiber, as well as the optical measurement section and optical reference section, are also simply referred to as measuring fiber and reference fiber, as well as measurement section and reference section, for the sake of better readability, specifically without altering the meaning of said terms.

Typically, a change in a mass, in particular a change in a tube wall thickness, of the respective heat-transfer tube results in a change in an elastic oscillation, in particular a natural oscillation, of the heat-transfer tube. By ascertaining or measuring the elastic oscillation, in particular the frequencies or natural frequencies thereof, a tube wall thickness of the heat-transfer tube can be determined. It is typically provided that an elastic oscillation of the heat-transfer tube produces a change in a length of the measurement section, in particular the measuring fiber. Expediently, the measuring fiber can be correspondingly connected to the heat-transfer tube in an oscillation-transferring manner, typically in a materially bonded manner, in order to achieve this. Normally, the measuring fiber is connected to the respective heat-transfer tube such that an expansion or contraction of the heat-transfer tube associated with the elastic oscillation of the heat-transfer tube results in an elastic expansion and relaxation, in particular a change in a length, of the measuring fiber corresponding to the oscillation of the heat-transfer tube. The reference fiber is normally arranged, in particular connected to the respective heat-transfer tube, such that a length of the reference fiber is essentially not influenced by a change in the mass or change in the elastic oscillation of the heat-exchanger tube. Preferably, the reference fiber and the measuring fiber are arranged such that said fibers are essentially exposed to the same temperature influences and/or pressure influences. The measuring fiber and reference fiber, in particular the respective interaction segment thereof, are typically arranged on the same heat-transfer tube or are connected thereto. Typically, an electromagnetic wave conducted over the measuring fiber or along the measurement section is referred to as a measuring wave, and an electromagnetic wave conducted over the reference fiber or along the reference section is referred to as a reference wave. The measuring wave and reference wave can have a path difference, in particular a phase difference, caused by an elastic oscillation of the heat-transfer tube. The path difference or the phase difference is thereby normally dependent on a frequency, in particular a natural frequency, of the elastic oscillation of the heat-transfer tube. It is typically provided that the measuring fiber and reference fiber are coupled to one another in order to bring a measuring wave and a reference wave into interference with one another to create an interference signal. The interference signal, also referred to as electromagnetic interference wave, is typically dependent on the path difference, in particular the phase difference, of the electromagnetic waves, in particular of the measuring wave and the reference wave, so that the interference signal corresponds to an elastic oscillation, in particular a frequency or natural frequency of the elastic oscillation, of the heat-transfer tube. The phase difference is thereby normally dependent on a mass of the heat-transfer tube, wherein the mass typically correlates with a natural frequency or resonant frequency of the elastic oscillation of the heat-transfer tube. It shall be understood that the fiber-optic sensor can be embodied accordingly. The measuring wave and reference wave are typically embodied to be coherent with one another in order to create the interference signal by interference after passing through the measurement section and reference section. It has proven effective if the measuring wave and reference wave originate from a shared electromagnetic emission source, in order to form the measuring wave and reference wave such that they are coherent with one another.

Typically, one or more frequencies, in particular natural frequencies, also referred to as resonant frequencies, of the elastic oscillation of the heat-transfer tube are ascertained using the fiber-optic sensor. The elastic oscillation, in particular the frequencies or natural frequencies thereof, of the heat-transfer tube normally correlates with a tube-wall thickness of the heat-transfer tube so that, by ascertaining or measuring the elastic oscillation, in particular the frequencies or natural frequencies thereof, the tube wall thickness of the heat-transfer tube can be determined. Normally, a frequency, in particular a natural frequency, increases as a tube wall thickness of the heat-transfer tube decreases. In particular, it has been shown that there is often an essentially linear relationship between a frequency, in particular a natural frequency, of the clastic oscillation of the heat-transfer tube and the tube wall thickness of the heat-transfer tube. In this manner, a robust evaluation can be practicably realized. Expediently, an intensity of the interference signal can be detected in a time-dependent manner. The detected intensity of the interference signal can be converted into a mathematical frequency space for evaluation, typically by means of a Fourier transform, in order to ascertain a natural frequency, in particular multiple natural frequencies. From the natural frequency or frequencies, the tube wall thickness can be determined. Expediently, the fiber-optic sensor can comprise one or more detectors in order to detect the interference signal. An evaluation of the interference signal, in particular an ascertaining of the natural frequency or determination of the tube wall thickness, can take place using an electronic data acquisition unit. The electronic data acquisition unit can be part of the heat exchanger, in particular part of the fiber-optic sensor. The electronic data acquisition unit can be designed for computer-assisted evaluation and, in particular, can be formed such that it comprises a microcontroller. An accuracy of the determination of the tube wall thickness of the heat-transfer tube is typically less than 100 μm.

The measuring fiber and reference fiber are typically embodied to conduct an electromagnetic wave, in particular the measuring wave and reference wave, respectively. The measuring fiber and reference fiber are normally a dielectric waveguide, usually formed such that they comprise or are made of quartz glass or plastic, preferably a fiber-optic cable. It is beneficial if, in a non-operational state of the heat exchanger, the measuring fiber or measurement section and the reference fiber or reference section essentially have an equal length.

The measuring fiber is typically connected in an oscillation-transferring manner to the heat-transfer tube, so that a length of the measuring fiber or of the measurement section changes corresponding to an elastic oscillation, in particular a frequency of the elastic oscillation, of the heat-transfer tube during operation of the heat exchanger. It is beneficial if, for this purpose, the measuring fiber comprises an interaction segment which is connected in an oscillation-transferring manner to the heat-transfer tube. The interaction segment can be wound at least once, preferably multiple times, around a circumference of the heat-transfer tube. The interaction segment of the measuring fiber can form one or more windings, in particular between 2 windings and 10 windings, preferably between 4 windings and 7 windings, usually approximately 5 windings, around a circumference of the heat-transfer tube. In this manner, an clastic oscillation of the heat transfer tube can efficiently act on the measuring fiber during operation of the heat exchanger. Alternatively or cumulatively, the interaction segment can have a meandering shape. In a simple implementation, the interaction segment can be shaped in a straight line. The measuring fiber, in particular the interaction segment thereof, can be connected in an oscillation-transferring manner to the heat-transfer tube in a material bond, in particular by means of a bonding agent. For this purpose, the bonding agent can be embodied to produce a rigid connection between the measuring fiber, in particular the interaction segment thereof, and the heat-transfer tube.

It is beneficial if the reference fiber is connected in an oscillation-decoupled manner to the heat-transfer tube, preferably wound around the heat-transfer tube. This is typically realized in that, during operation of the heat exchanger, a length of the reference fiber or of the reference section essentially does not change with an elastic oscillation, in particular a frequency of the elastic oscillation, of the heat-transfer tube. For this purpose, the reference fiber can comprise an interaction segment which is connected in an oscillation-decoupled manner to the heat-transfer tube. In this manner, similar boundary conditions can be realized for the measuring fiber or measurement section and the reference fiber or reference section, in order to achieve a high accuracy of the determination of the tube wall thickness using the sensor. The interaction segment can be wound at least once, preferably multiple times. around a circumference of the heat-transfer tube. The interaction segment of the reference fiber can form one or more windings, in particular between 2 windings and 10 windings, preferably between 4 windings and 7 windings. usually approximately 5 windings, around a circumference of the heat-transfer tube. Alternatively or cumulatively, the interaction segment can have a meandering shape. In a simple implementation, the interaction segment can be shaped in a straight line. The reference fiber, in particular the interaction segment thereof, can be connected in an oscillation-decoupled manner to the heat-transfer tube in a material bond, in particular by means of a bonding agent. For this purpose, the bonding agent can produce an elastic connection between the reference fiber and the heat-transfer tube, in particular the interaction segment thereof. It has proven effective if the bonding agent is formed such that it comprises polydimethylsiloxane (PDMS). Preferably, the interaction segment of the measuring fiber and the interaction segment of the reference fiber have the same shape. It is advantageous if the interaction segment of the measuring fiber and the interaction segment of the reference fiber form an equal number of windings around the heat-transfer tube. Typically, the interaction segment of the measuring fiber and the interaction segment of the reference fiber are arranged adjacently to one another on the same heat-transfer tube, specifically connected to said same heat-transfer tube, in particular along a longitudinal extension of the heat-transfer tube. It has proven effective if a spacing between the interaction segments is thereby less than 30 mm, preferably less than 10 mm. Typically, the spacing is thereby between 1 mm and 30 mm, preferably approximately 5 mm.

The heat-transfer tubes are typically embodied for conducting the first fluid in order to transfer heat between the first fluid and the second fluid through tube walls of the heat-transfer tubes. It is preferably provided that, during operation of the heat exchanger, the second fluid is in, in particular direct, contact with the heat-transfer tubes or the tube walls. The first fluid is typically a first fluid stream conducted through the heat-transfer tubes during operation of the heat exchanger. During operation of the heat exchanger, the second fluid can be a second fluid stream that normally flows around the heat-transfer tubes.

The heat exchanger typically comprises a fluid chamber for accommodating the second fluid, wherein the heat-transfer tubes run inside of the fluid chamber. The fluid chamber typically forms a fluid chamber cavity between fluid chamber walls of the fluid chamber and the heat-transfer tubes, in order to accommodate the second fluid with the fluid chamber cavity for a transfer of heat between the first fluid and the second fluid. The heat-transfer tubes typically run through the fluid chamber cavity. Normally, it is provided that, during operation of the heat exchanger, the second fluid is conducted through the fluid chamber cavity, in particular such that the second fluid flows around the heat-transfer tubes. Expediently, the fluid chamber cavity can be embodied in the form of one or more channels, in order to conduct the second fluid using the channels during operation of the heat exchanger. The fluid chamber typically comprises at least one fluid chamber inlet and at least one fluid chamber outlet, in order to conduct the second fluid into the fluid chamber, in particular into the fluid chamber cavity, via the fluid chamber inlet and to remove the second fluid, normally after heat transfer has occurred between the first fluid and second fluid, again from the fluid chamber, in particular from the fluid chamber cavity, via the fluid chamber outlet. The fluid chamber is typically formed such that it comprises, in particular is made of, metal, preferably an iron alloy. particularly preferably steel.

Normally, the heat-transfer tubes are spaced apart from one another at least in sections, so that during operation of the heat exchanger, the second fluid can flow through between the heat-transfer tubes for a transfer of heat with the heat-transfer tubes. This applies in particular inside of the fluid chamber or the fluid chamber cavity thereof.

Typically, the first fluid and the second fluid are embodied to be liquid and/or gaseous. For example, the first fluid and the second fluid can be formed such that they comprise, in particular are made of, liquid and gaseous water. It can be provided that the first fluid and second fluid are embodied such that they comprise, in particular are made of, a liquid medium and a gaseous medium, wherein the liquid medium and the gaseous medium of the respective fluid flow through the heat exchanger in opposing directions, typically such that they contact one another. For example, the first fluid can be formed such that it comprises a liquid medium and a gaseous medium, wherein in the respective heat-transfer tube, the media flow through the heat-transfer tube in opposing directions such that they contact one another.

The heat-transfer tubes typically extend between a first tube plate and a second tube plate, wherein the tube plates delimit the fluid chamber cavity for accommodating the second fluid, wherein the heat-transfer tubes end in pass-through openings of the respective tube plate or are guided through the pass-through openings. Typically, a fluid fed through pass-through openings of one of the plates is conducted through the heat-transfer tubes to the pass-through openings of the other tube plate. The heat-transfer tubes are normally connected to the tube plates in a fluid-tight manner. Typically, the respective tube plate is embodied to be plate-shaped with multiple flow channels oriented transversely, in particular orthogonally, to a longitudinal extension of the tube plate, which flow channels form the respective pass-through openings. The tube plates can be embodied as being parts of fluid chamber walls of the fluid chamber. The heat exchanger typically comprises at least one first and at least one second tube plate of this type. The tube plates are typically formed such that they comprise, in particular are made of, metal, preferably an iron alloy, particularly preferably steel.

In the fluid chamber, one or more fluid-guiding surfaces can be present in order to define a flow path of the second fluid using the fluid-guiding surfaces. The respective fluid-guiding surface is typically embodied to inhibit, in sections, a fluid flow of the second fluid between the heat-transfer tubes. The fluid-guiding surfaces can define a flow path with multiple deflecting curves. along which fluid path the second fluid is guided from the fluid chamber inlet to the fluid chamber outlet. For example, the flow path can have a meandering shape. Typically, a plurality of the heat-transfer tubes runs through the respective guiding surface. Normally, multiple guiding surfaces are provided which cross the heat-transfer tubes and are spaced apart from one another. The respective fluid-guiding surface is typically oriented transversely, in particular orthogonally, to a longitudinal extension of the heat-transfer tubes. Normally, multiple fluid-guiding surfaces are provided which are spaced apart from one another in a longitudinal direction of the heat-transfer tubes. Typically, an intermediate space between a plurality of the heat-transfer tubes is essentially closed off by the respective fluid-guiding surface, in order to inhibit a flow of the second fluid through the intermediate space. The respective fluid-guiding surface can be embodied to close off a majority of the intermediate spaces between the heat-transfer tubes to a flow of the second fluid in a cross section through the fluid chamber. The fluid-guiding surfaces can be formed using guide walls arranged in the fluid chamber. The fluid-guiding surfaces are normally embodied to be plate-shaped. The fluid chamber normally comprises one or more guiding surfaces of this type.

Typically, a plurality of the heat-transfer tubes is connected to one another by stabilizing elements in order to stabilize the heat-transfer tubes during operation of the heat exchanger. The respective stabilizing element can be embodied to be plate-shaped, wherein a longitudinal extension of the stabilizing element is normally oriented transversely, in particular orthogonally, to a longitudinal extension of the heat-transfer tubes connected by the stabilizing element. Typically, the heat-transfer tubes run through the stabilizing element. The stabilizing elements are customarily referred to as baffles. Normally, multiple stabilizing elements which are spaced apart from one another and connect the heat-transfer tubes to one another are provided along a longitudinal extension of the heat-transfer tubes. In particular, the fluid-guiding surfaces can be formed by the stabilizing elements. The stabilizing elements can then serve both to stabilize the heat-transfer tubes and to define a flow path of the second fluid.

Typically, the measuring fiber of the respective fiber-optic sensor is connected to the respective heat-transfer tube in an oscillation-transferring manner inside of the fluid chamber. It is beneficial if a detector of the fiber-optic sensor is arranged outside of the fluid chamber, in particular of the fluid chamber cavity, for the detection of the interference signal of the electromagnetic waves guided along the measurement section and of the electromagnetic waves guided along the reference section. Typically, the electronic data acquisition unit is also arranged outside of the fluid chamber, in particular of the fluid chamber cavity. As a result, the detector and the electronic data acquisition unit are protected against loads, in particular pressure loads, and/or temperature loads, in particular of the first and second fluid. Normally, the measuring fiber and the reference fiber run, at least in sections, through the fluid chamber, in particular the fluid chamber cavity, or through the second fluid during operation of the heat exchanger. Typically, the interaction segment of the measuring fiber and the interaction segment of the reference fiber are connected to the respective heat-transfer tube inside of the fluid chamber. The fluid chamber can comprise one or more fiber feed-throughs, with which the measuring fiber and reference fiber are guided through a fluid chamber wall of the fluid chamber, in particular are guided out of the fluid chamber, in a fluid-tight manner.

Expediently, the fiber-optic sensor can comprise an electromagnetic emission source, preferably a laser, for producing and emitting electromagnetic waves, in particular the measuring wave and reference wave, wherein the electromagnetic emission source is coupled to the measuring fiber and the reference fiber in order to introduce an electromagnetic wave into the measuring fiber and the reference fiber. The electromagnetic waves introduced into the measuring fiber and the reference fiber are normally coherent with one another, so that the electromagnetic waves can create an interference or an interference signal after passing through the measurement section and reference section. It is advantageous if the electromagnetic emission source or the electromagnetic wave, in particular the measuring wave and reference wave, have a coherence length of more than 0.5 mm, in particular more than 1 mm. preferably more than 2 mm, particularly preferably more than 5 mm. Typically, the coherence length is between 1 mm and 10 mm. Preferably, the electromagnetic emission source, in particular the laser, is embodied to emit an electromagnetic wave, in particular a light wave, with a wavelength between 500 nm and 2000 nm. in particular between 1000 nm and 1500 nm, preferably of approximately 1300 nm. It is advantageous for a robust measurement or determination of the tube wall thickness if the laser is built for the emission of electromagnetic waves with a vertical-cavity surface-emitting laser diode (VCSEL). The interference signal typically has an essentially periodic structure. It is beneficial if, downstream from the electromagnetic emission source in a feed direction, an optical isolator, also referred to as an optical diode, is arranged downstream, in order to minimize, in particular to prevent, electromagnetic back reflections to the electromagnetic emission source. Feed direction typically denotes a direction in which an electromagnetic wave is fed to the measuring fiber and the reference fiber using the electromagnetic emission source.

It has been shown that it is also possible, although it is less preferred in terms of a robustness, to determine the tube wall thickness if the coherence length is between 10 μm and 500 μm, in particular between 20 μm and 100 μm, preferably between 25 μm and 50 μm, for example approximately 30 μm. Normally, the interference signal in this case has a non-periodic structure with a maximum, in particular multiple maxima. The interference signal, or the non-periodic structure, often comprises one or more Gaussian function-like substructures. A maximum, in particular a distance between a plurality of the maxima, of the interference signal, in particular of the Gaussian function-like substructures, normally corresponds to a path difference between the measuring wave and reference wave. It is then beneficial if, in a non-operating state of the heat exchanger. a length difference between a length of the measuring fiber or measurement section and a length of the reference fiber or reference section is less than the coherence length.

It is advantageous if the measuring fiber and the reference fiber respectively comprise a reflection element or connect to such a reflection element, in order to reflect an electromagnetic wave conducted along the measurement section and reference section, in particular back along the measurement section and reference section, respectively, using the reflection element. Typically, with the reflection element, the measuring wave is reflected back after passing through the measurement section and the reference wave is reflected back after passing through the reference section, along the measurement section and reference section, respectively. The reflection element preferably comprises a reflection surface in order to reflect the respective electromagnetic wave. It is expedient if the reflection element or the reflection surface has a reflectance of more than 90%, in particular more than 95%, preferably more than 98%. The reflection element can be a mirror. It has proven effective if a reflection element of this type is respectively arranged at a fiber end of the measuring fiber and the reference fiber. Typically, the fiber end is the one of the fiber ends of the measuring fiber and reference fiber which is arranged downstream along the respective fiber in a feed direction of the electromagnetic wave with the electromagnetic emission source. The reflection element is normally arranged downstream from the measurement section and reference section along the respective fiber in a feed direction. The reflection element can be formed such that it comprises. in particular is formed by, a metal layer arranged at the fiber end of the measuring fiber and reference fiber. The metal layer can be formed such that it comprises, in particular is made of, gold, sliver, and/or aluminum. Preferably, the metal layer is applied to the fiber end using sputtering. The reflection element can be a Bragg mirror, in particular a dielectric mirror. The reflection element can be formed such that it comprises one or more thin films that can be applied on top of one another. The thin films can be applied using thin film deposition. The thin films can be formed such that they comprise, in particular are essentially made of, magnesium fluoride, silicon dioxide, tantalum(V) oxide, zinc sulfide, and/or titanium dioxide.

Preferably, the fiber-optic sensor can have an interferometer design according to the type of a Michelson interferometer, wherein electromagnetic waves run along the measurement section via the measuring fiber and along the reference section via the reference fiber, are reflected at a respective end of the measurement section and reference section, in particular the respective fiber end, in order to superimpose the reflected electromagnetic waves to create an interference signal.

It is beneficial if the measuring fiber and the reference fiber are coupled to one another at a coupling site in order to create an interference signal using an electromagnetic wave transmitted along the measurement section and an electromagnetic wave transmitted along the reference section. The coupling site is typically realized by a mechanical connection of the measuring fiber and reference fiber.

It has proven effective if the fiber-optic sensor comprises an optical coupler having multiple input lines and multiple output lines, wherein the input lines and the output lines are connected to one another for the distributed transmission of electromagnetic waves. The optical coupler can form the coupling site. Typically, the input lines and output lines are connected such that an electromagnetic wave fed to the optical coupler via the input line is transmitted to the multiple output lines, and an electromagnetic wave fed to the optical coupler via one of the output lines is transmitted to the multiple input lines. It is practicable if the electromagnetic emission source is connected to one of the input lines and the measuring fiber and the reference fiber are respectively connected to one of the output lines, so that an electromagnetic wave introduced into the input line using the emission source is conducted into the measuring fiber and the reference fiber via the output lines. Typically, the measuring fiber and the reference fiber are respectively connected to an output line so that electromagnetic waves introduced into the output lines via the measuring fiber and the reference fiber, in particular electromagnetic waves reflected back along the measuring fiber and reference fiber, are transmitted to one or more of the input lines, so that the electromagnetic waves are outputted as an interference signal at the respective input line. Expediently, a detector for the detection of the interference signal can be arranged at one or more of the input lines. It is beneficial if a detector, preferably formed such that it comprises a photodiode, is respectively connected to one or more of the input lines, in order to detect at the input lines, using the respective detector, an electromagnetic wave respectively reflected back along the measuring fiber and reference fiber into the output line, as an interference signal. For example, the optical coupler can comprise at least three input lines and at least two output lines, wherein the electromagnetic emission source connects to one of the input lines and a detector respectively connects to two other input lines, and wherein the measuring fiber connects to one of the output lines and the reference fiber connects to another output line.

The detector can be embodied to detect the interference signal, in particular an intensity of the interference signal, in a time-dependent manner. The detector is typically an optoelectronic detector that is normally embodied such that it comprises or is a photodiode. The detector is typically connected to the electronic data acquisition unit for the transfer of data.

The second fluid typically has a pressure of more than 30 bar, in particular between 30 bar and 200 bar, preferably approximately 180 bar, and/or a temperature of more than 80° C., in particular between 80° C. and 300° C., preferably approximately 230° C., during operation of the heat exchanger. The first fluid can have a higher pressure and/or a higher temperature than the second fluid. Typically, it is provided, or the heat exchange is embodied such that, the measuring fiber runs, at least in sections, through the second fluid during operation of the heat exchanger. It is beneficial if the fiber-optic sensor is embodied such that the measuring fiber and the reference fiber can be used at a working pressure of more than 30 bar and/or a working temperature of more than 80° C. In particular, it is correspondingly beneficial if the working pressure is between 30 bar and 200 bar, preferably approximately 180 bar, and/or the working temperature is between 80° C. and 300° C., preferably approximately 230° C.

It is advantageous if the measuring fiber and the reference fiber run, at least in sections, inside of a protective sheath for protection against an ambient pressure and/or an ambient temperature. Typically, the protective sheath is formed such that it comprises, in particular is made of, metal, in particular such that it comprises or is made of copper and/or iron, preferably steel, particularly preferably austenitic steel. Alternatively, the protective sheath can be formed such that it comprises, in particular is essentially made of, plastic, in particular polyimide. It is beneficial if a segment of the measuring fiber and a segment of the reference fiber, which segment runs inside of the fluid chamber, in particular through the second fluid during operation of the heat exchanger, runs inside of a protective sheath of this type. The segment can be formed such that it comprises a predominant portion of a, in particular essentially an entire, longitudinal extension of the measuring fiber and reference fiber that runs inside of the fluid chamber. The protective sheath can be realized such that it comprises or is a coating applied to the measuring fiber and to the reference fiber. The measuring fiber and the reference fiber can respectively be embodied as being part of an optical cable, wherein the protective sheath forms an outer sleeve of the optical cable.

It is advantageous if multiple fiber-optic sensors that are arranged on various of the heat-transfer tubes for determining a respective tube wall thickness have a shared electromagnetic emission source. Expediently. the electromagnetic emission source can be coupled to the measuring fibers and reference fibers of the fiber-optic sensors such that an electromagnetic wave produced using the electromagnetic emission source is split and conducted into the measuring fibers and reference fibers. This can be realized using one or more optical feed fibers which connect the electromagnetic emission source and the measuring fibers and reference fibers for the transmission of an electromagnetic wave. Expediently, the feed fiber can comprise a main branch and multiple side branches branching off from the main branch, so that an electromagnetic wave conducted into the main branch using the electromagnetic emission source is split into the side branches in order to guide the electromagnetic wave to the measuring fiber and reference fiber of the respective fiber-optic sensor via the side branches. The respective fiber-optic sensor can comprise an, in particular aforementioned, optical coupler, wherein the feed fiber is connected to an input line of the respective optical coupler, in order to feed an electromagnetic wave into the input line via the feed fiber. Expediently, one side branch each can respectively be connected to an input line of the respective fiber-optic sensor for the transmission of an electromagnetic wave.

It is beneficial if multiple fiber-optic sensors that are arranged on various of the heat-transfer tubes for determining a respective tube wall thickness have a shared, in particular aforementioned, electronic data acquisition unit or are connected to such a unit.

It is advantageous if the fiber-optic sensor bas multiple electromagnetic emission sources with a different wavelength and/or coherence length of the producible electromagnetic wave thereof. The electromagnetic emission sources can be embodied as described in the present document. It is beneficial if the electromagnetic emission sources are coupled to the measuring fiber and reference fiber such that electromagnetic waves produced using different emission sources can be transmitted via the measuring fiber and reference fiber in a superimposed manner. It is advantageous if multiple detectors are provided, wherein the detectors are embodied and/or connected to the measuring fiber and reference fiber, in particular via the optical coupler, such that various of the interference signals are detected using the detectors. It is practicable if the detectors are coupled to the measuring fiber and reference fiber via a wavelength-selecting demultiplexer, in order to output interference signals from electromagnetic waves of a differing wavelength at different outputs of the demultiplexer. The detectors are in this case typically connected to different outputs of the demultiplexer for the detection of an interference signal. An input of the demultiplexer can be connected to the measuring fiber and reference fiber, typically via the optical coupler, for the transmission of electromagnetic waves. The different emission sources then typically have different wavelengths of the electromagnetic waves that can produced thereby.

For a high accuracy of a determination of a tube wall thickness, it is advantageous if a correlation function between the tube wall thickness and one or more natural frequencies of an elastic oscillation of a heat-transfer tube is established. The correlation function can be established such that it is dependent on a material and a size, in particular a diameter and/or a length, of the heat-transfer tube. Alternatively or cumulatively, the correlation function can be established with a calibration, wherein typically a natural frequency of an elastic oscillation of a heat-transfer tube is measured at different known tube wall thicknesses of the heat-transfer tube.

Typically, a fiber-optic sensor, in particular the measuring fiber or reference fiber thereof, is respectively arranged on a plurality of the heat-transfer tubes of the heat exchanger. It is also possible for multiple fiber-optic sensors to be respectively arranged on a plurality of the heat-transfer tubes. The heat-transfer tubes are normally formed such that they comprise, in particular are made of, metal, in particular an iron alloy, preferably a steel alloy.

Typically, the fiber-optic sensor, in particular the measuring fiber or reference fiber thereof, is arranged in an arrangement region on the respective heat-transfer tube. The arrangement region is preferably a region in which preferably corrosion occurs during operation of the heat exchanger. The arrangement region often depends on a production capacity. It is beneficial if the respective fiber-optic sensor, in particular the measuring fiber or reference fiber thereof, is arranged in an arrangement region on the respective heat-transfer tube, wherein the arrangement region, in particular in a flow direction of the first fluid through the heat-transfer tube, starting from an entry of the heat-transfer tube into the fluid chamber, in particular the fluid chamber cavity, along a longitudinal extension of the heat-transfer tube, is defined by two thirds of a longitudinal extension of the heat-transfer tube inside of the fluid chamber or of the fluid chamber cavity. In particular, the arrangement region of the respective heat-transfer tube can extend, in particular in a flow direction of the first fluid through the heat-transfer tube. typically starting from an entry of the heat-transfer tube into the fluid chamber, in particular the fluid chamber cavity, along a longitudinal extension of the heat-transfer tube with a length of 30%, in particular 20%, preferably 10% of a longitudinal extension of the heat-exchanger tube inside of the fluid chamber or of the fluid chamber cavity. This preferably applies if the heat exchanger, in particular a stripper, is part of a urea plant for the production of urea, in particular for urea synthesis, wherein the urea plant has a production capacity of less than 2700 MTPD (metric tons per day). Alternatively, the arrangement region of the respective heat-transfer tube can be defined, in particular in a flow direction of the first fluid through the heat-transfer tube. typically starting from an entry of the heat-transfer tube into the fluid chamber, in particular the fluid chamber cavity, along a longitudinal extension of the heat-transfer tube, by a segment of a second third of a longitudinal extension of the heat-transfer tube inside of the fluid chamber or of the fluid chamber cavity. This preferably applies if the heat exchanger, in particular a stripper, is part of a urea plant for the production of urea, in particular for urea synthesis, wherein the urea plant has a production capacity of greater than or equal to 2700 MTPD (metric tons per day). It has been shown that a material removal or a wear of the heat-transfer tube is normally especially great in this arrangement region of the respective heat-transfer tube, which is why it is beneficial to position the fiber-optic sensors in said region. Normally, the arrangement region, in particular in a flow direction of the first fluid through the heat-transfer tube, is arranged in the first third and/or in the second third of a length of the fluid chamber or of the fluid chamber cavity. A region of a center of the length of the fluid chamber or of the fluid chamber cavity is thereby preferred in the second third.

The other object is attained with a method of the type named at the outset for operating a heat exchanger if, on one or more heat-transfer tubes with which a first fluid is transported in order to transfer heat between the first fluid and a second fluid via the heat-transfer tubes, a fiber-optic sensor is respectively arranged, wherein an clastic oscillation, in particular a natural oscillation, of the respective heat-transfer tube is interferometrically ascertained using the fiber-optic sensor during operation of the heat exchanger, in order to determine a tube wall thickness of the respective heat-transfer tube during operation of the heat exchanger. The method can in particular be implemented using an aforementioned heat exchanger. Typically, the tube wall thickness of the heat-transfer tube denotes, in a cross section of the heat-transfer tube, an, in particular radial, distance between an inner surface and an outer surface of a tube wall of the heat-transfer tube. Typically, the second fluid is located outside of the heat-transfer tubes, so that heat is transferred between the first fluid and second fluid through the tube walls of the heat-transfer tubes.

As stated in the foregoing in particular, a robust determination of a tube wall thickness of a tube wall of the respective heat-transfer tube, in particular in a high-pressure and/or high-temperature environment, in a heat exchanger is thus enabled during operation of the heat exchanger. As a result, an operation, in particular a process management, and/or a maintenance of the heat exchanger can take place depending on the tube wall thickness determined using the fiber-optic sensor. In this manner, an optimized usability of the heat exchanger or an optimized operation of the heat exchanger is rendered possible.

It shall be understood that the method for operating a heat exchanger can be embodied according to the features and effects which are described, in particular in the foregoing, in the present document within the scope of a heat exchanger. The same also applies to the heat exchanger with regard to the method.

It is advantageous if the fiber-optic sensor comprises an optical measuring fiber, which constitutes a measurement section, and an optical reference fiber, which constitutes a reference section, wherein the measuring fiber is connected in an oscillation-transferring manner to the heat-transfer tube, wherein an elastic oscillation, in particular a frequency of the elastic oscillation, of the heat-transfer tube is ascertained by detection, in particular measurement, of an interference signal from an electromagnetic wave guided along the measurement section and an electromagnetic wave guided along the reference section. Typically, an interference is produced between an electromagnetic wave guided along the measurement section and an electromagnetic wave guided along the reference section, so that the electromagnetic waves create an interference signal. The interference signal is typically detected using a detector, in order to ascertain a frequency, in particular a natural frequency. of the elastic oscillation of the heat-transfer tube using the detected interference signal. Multiple frequencies, in particular natural frequences, of the elastic oscillation can be ascertained. From the frequency or frequencies, in particular natural frequencies, it is possible to determine the tube wall thickness.

Preferably, the fiber-optic sensor is embodied to determine the tube wall thickness of the heat-transfer tube with an accuracy of less than 100 μm.

It is particularly beneficial if the method for operating the heat exchanger is used for urea synthesis. The heat exchanger can, in particular for urea synthesis, be embodied as a stripper for stripping, wherein it is typically provided that a liquid phase and gas phase having opposing flow directions are brought into contact with one another, normally inside of the heat-transfer tubes. It is beneficial if a first medium flows through the respective heat-transfer tube in a flow direction and a second medium flows through the heat-transfer tube in a direction opposed to the flow direction, in order to react with one another, wherein one of the media is normally liquid and the other medium is gaseous. The typically takes place inside of the fluid chamber or of the fluid chamber cavity. The first fluid can be formed such that it comprises or is made of the first medium and second medium. It is beneficial if the heat-transfer tubes and a flow direction of the first fluid through the heat-transfer tubes are oriented essentially vertically, particularly if the heat exchanger is a stripper. The heat exchanger or stripper normally comprises a plurality, in particular more than 10, preferably more than 50, especially preferably more than 100, particularly preferably more than 1000, heat-transfer tubes.

Typically, the heat exchanger, particularly if said heat exchanger is a stripper, comprises a first inlet, via which the first medium can be fed into the heat-transfer tubes, and a second inlet, via which the second medium can be fed into the heat-transfer tubes, so that inside of the fluid chamber or the fluid chamber cavity, the media flow through the heat-transfer tubes with opposing flow directions in order to react with one another. In relation to the fluid chamber cavity, the first inlet and the second inlet are typically connected to the heat-transfer tubes in a fluid-conducting manner at different ends of the heat-transfer tubes. The heat exchanger normally comprises at least one outlet for removing from the heat-transfer tubes a product formed by a reaction between the first medium and the second medium. Practicably, the heat exchanger can comprise a first outlet, via which a first product can be removed from the heat-transfer tubes, and a second outlet, via which a second product can be removed from the heat-transfer tubes, wherein in relation to the fluid chamber cavity, the outlets are connected to the heat-transfer tubes in a fluid-conducting manner at different ends of the heat-transfer tubes. The first product and second product are typically formed by means of or as a result of the reaction between the first medium and second medium. This applies in particular if the heat exchanger is embodied as a stripper.

For urea synthesis, the first medium is typically formed such that it comprises, in particular is made of, urea, ammonium carbamate, and ammonia, and the second medium is formed such that it comprises, in particular is made of, gaseous carbon dioxide (CO₂). In this manner, urea, in particular of high purity, can be separated as a product, in particular a first product, which urea is conducted out of the heat-transfer tube, typically at one of the ends of the heat-transfer tube or via the first outlet. Expediently, formed process gas, normally gaseous ammonia (NH₃) and/or gaseous carbon dioxide (CO₂), can be conducted out of the heat-transfer tube, usually at another end of the heat-transfer tube or via the second outlet. The second fluid can be formed such that it comprises, in particular is made of, liquid and/or gaseous water. The stripper can be embodied and operated as described in the present document, in particular with regard to the heat exchanger.

It is expedient if the electromagnetic wave guided using the measuring fiber or reference fiber has a coherence length of more than 2 mm, in particular more than 5 mm. As a result, a robust interference signal can be realized by producing an interference between the electromagnetic wave guided along the measurement section and the electromagnetic wave guided along the reference section. In particular, the coherence length can be as described in the foregoing.

The second fluid typically has a pressure of more than 30 bar, in particular between 30 bar and 200 bar, preferably approximately 180 bar, and/or a temperature of more than 80° C., in particular between 80° C. and 300° C., preferably approximately 230° C.

It shall be understood that the fiber-optic sensor and the embodiment and/or arrangement thereof on the heat-transfer tube typically refers to the heat-transfer tube on which the fiber-optic sensor is arranged, or to which the fiber-optic sensor is connected for measuring the tube wall thickness of the heat-exchanger tube. Expediently, multiple fiber-optic sensors can be arranged on various of the heat-transfer tubes or connected to various of the heat-transfer tubes, in particular with a respective implementation described in the present document.

Additional features, advantages, and effects of the invention follow from the following description of an exemplary embodiment. In the drawings which are thereby referenced:

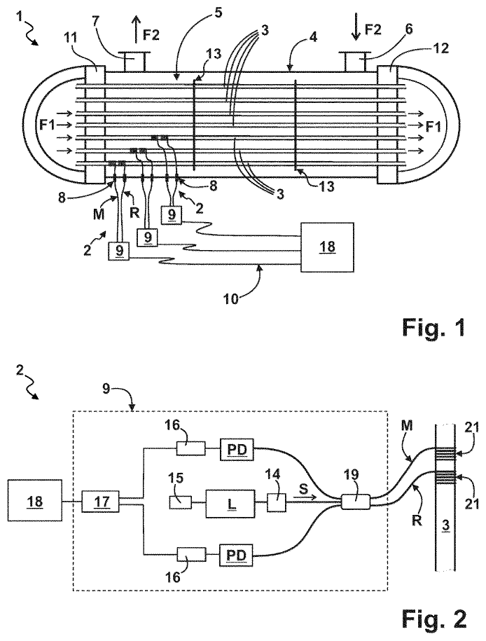

FIG. 1 shows a schematic illustration of a heat exchanger with a fiber-optic sensor;

FIG. 2 shows a schematic illustration of a fiber-optic sensor which is arranged on a heat-transfer tube;

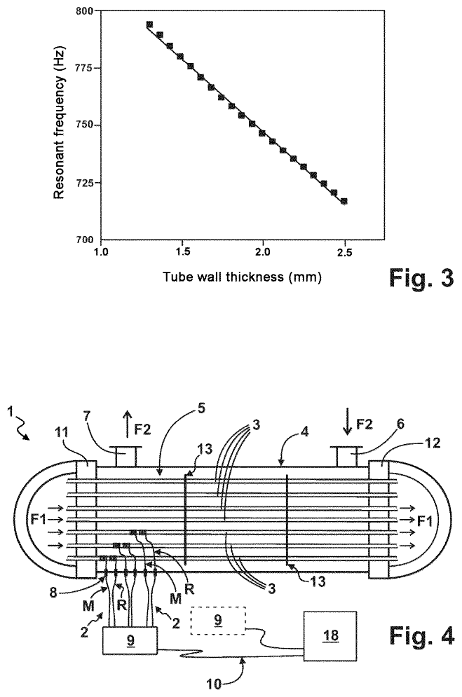

FIG. 3 shows a graph which illustrates a resonant frequency over a tube wall thickness;

FIG. 4 shows a schematic illustration of a further heat exchanger with a fiber-optic sensor;

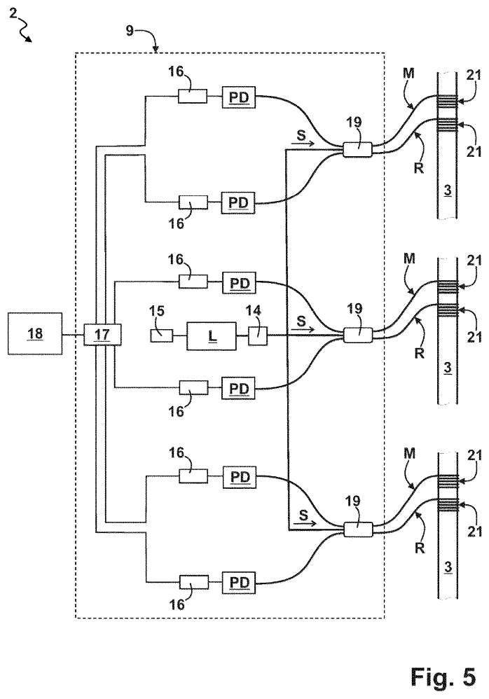

FIG. 5 shows a schematic illustration of fiber-optic sensors arranged on heat-transfer tubes, having a shared electromagnetic emission source:

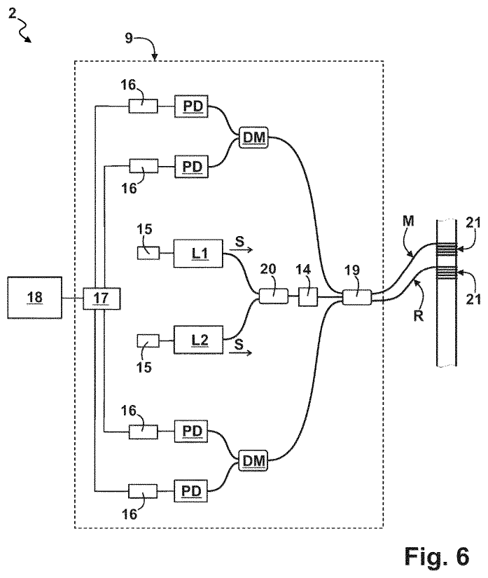

FIG. 6 shows a schematic illustration of a further fiber-optic sensor which is arranged on a heat-transfer tube;

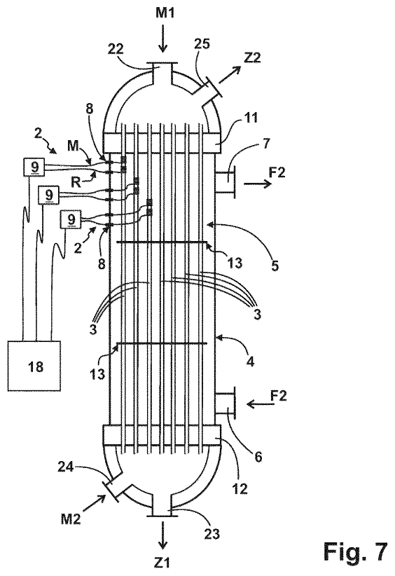

FIG. 7 shows a schematic illustration of a heat exchanger embodied as a stripper, having a fiber-optic sensor.

In FIG. 1, a heat exchanger 1 is schematically illustrated, wherein the heat exchanger 1 comprises multiple heat-transfer tubes 3 and a fluid chamber 4, wherein the heat-transfer tubes 3 run through the fluid chamber 4 in order to conduct a first fluid F1 through the heat-transfer tubes 3 during operation of the heat exchanger 1 and to conduct a second fluid F2 through the fluid chamber 4 such that said second fluid F2 surrounds the heat-transfer tubes, so that heat is transferred between the first fluid F1 and the second fluid F2 through the tube walls of the heat-transfer tubes 3. The fluid chamber 4 forms a fluid chamber cavity 5 between fluid chamber walls and the heat-transfer tubes 3 in order to accommodate the second fluid F2, and through which cavity the second fluid F2 is conducted. The fluid chamber 4 comprises a fluid chamber inlet 6 for feeding the second fluid F2 into the fluid chamber 4, in particular the fluid chamber cavity 5, and a fluid chamber outlet 7 for removing the fluid from the fluid chamber 4, in particular the fluid chamber cavity 5. Typically, the heat-transfer tubes 3 are guided through the fluid chamber 4 such that they are spaced apart from one another, so that the second fluid F2 can flow through between the heat-transfer tubes 3. The heat exchanger 1 can be embodied as a stripper. The heat exchanger 1, in particular the stripper, is often embodied or oriented such that a longitudinal direction of the heat-transfer tubes 3 is essentially vertically oriented.

Fiber-optic sensors 2 are arranged on a plurality of the heat-transfer tubes 3 in order to determine a tube wall thickness of the respective heat-transfer tube 3 during operation of the heat exchanger 1, using the respective heat exchanger 1. The respective fiber-optic sensor 2 is embodied to interferometrically ascertain a frequency. in particular a natural frequency, of an elastic oscillation of the heat-transfer tube 3 during operation of the heat exchanger 1. The respective fiber-optic sensor 2 comprises an optical measuring fiber M and an optical reference fiber R, in order to guide an electromagnetic measuring wave along a measurement section using the measuring fiber M and to guide an electromagnetic reference wave along a reference section using the reference fiber R, which can also be seen in FIG. 2. The measuring fiber M and reference fiber R are connected to the same heat-transfer tube 3, wherein an interaction segment 21 of the measuring fiber M and an interaction segment 21 of the reference fiber R. on the heat-transfer tube 3 are adjacently wound around the same heat-transfer tube 3 multiple times. The respective interaction segment 21 is formed using an end region of the measuring fiber M or reference fiber R. The measuring fiber M is connected in an oscillation-transferring manner to the heat-transfer tube 3, so that an elastic oscillation of the heat-transfer tube 3 changes an optical length of the measurement section. The reference fiber R is connected in an oscillation-decoupled manner to the heat-transfer tube 3, so that an optical length of the reference section is not significantly influenced by the elastic oscillation of the heat-transfer tube 3. The optical sensor 2 comprises a laser as an electromagnetic emission source L, in order to introduce an electromagnetic wave into the measuring fiber M as an electromagnetic measuring wave and an electromagnetic wave into the reference wave as an electromagnetic reference wave using the laser. A change in the length of the measurement section can produce a path difference between the measuring wave and reference wave, so that the elastic oscillation, in particular a natural frequency of the elastic oscillation, can be detected or measured using a detector PD of the fiber-optic sensor 2 by producing an interference of the measuring wave and of the reference wave to create an interference signal. The measuring fiber M and the reference fiber R respectively comprise at the fiber end thereof a reflection element, in order to reflect the measuring wave and reflection wave back again along the measuring fiber M and reference fiber R. The measuring fiber M and reference fiber R are coupled to one another at a coupling site in order to create an interference signal using the measuring wave and reference wave. The interaction segment 21 of the measuring fiber M and the interaction segment 21 of the reference fiber R are connected to the respective heat-transfer tube 3 inside of the fluid chamber 4, in particular of the fluid chamber cavity 5, and the measuring fiber M and reference fiber R are guided to the outside through a fluid chamber wall of the fluid chamber 4, in order to measure the interference signal outside of the fluid chamber 4 using the detector PD. The detectors PD and electromagnetic emission source L are located outside of the fluid chamber 4 or the fluid chamber cavity 5, typically inside of a sensor housing 9. The measuring fiber M and reference fiber R are typically guided through the fluid chamber wall in a fluid-tight manner using one or more fiber feed-throughs 8. The fiber-optic sensors 2 can be connected to an, in particular shared, electronic data collection unit 18 for the transfer of data, typically via electric data lines 10. The electronic data collection unit 18 can be an electronic data processing system, for example. In order to withstand high temperatures and/or high pressures in the heat exchanger 1, it is beneficial if, inside of the fluid chamber 4, the measuring fiber M and the reference fiber R preferably respectively run inside of a protective sheath which can be embodied as a coating applied to the measuring fiber M and the reference fiber R. In order to keep lengths of measuring fibers M and reference fibers R short, it is beneficial if multiple separate fiber-optic sensors 2 are present which, in particular, respectively comprise an individual sensor housing 9 and an individual electromagnetic emission source L.

Normally, the heat-transfer tubes 3 respectively extend between a first tube plate 11 and a second tube plate 12, wherein the tube plates are embodied as being part of fluid chamber walls of the fluid chamber 4 or delimit the fluid chamber cavity 5. The respective heat-transfer tube 3 is guided through the first tube plate 11 and the second tube plate 12. The fluid chamber 4 comprises multiple stabilizing elements 13, typically denoted as baffles, which connect a plurality of the heat-transfer tubes 3 to one another in order to stabilize the heat-transfer tubes 3 using the stabilizing elements 13 during operation of the heat exchanger 1. It is advantageous if the interaction segments 21 of the measuring fiber M and reference fiber R of the respective fiber-optic sensor 2 are arranged in an arrangement region on the respective heat-transfer tube 3, which arrangement region lies in a first third and/or in a second third of a longitudinal extension of the heat-transfer tube 3 inside of the fluid chamber 4 or of the fluid chamber cavity 5 in a flow direction of the first fluid F1 through the heat-transfer tube 3. Preferably, the interaction segments 21 of the measuring fiber M and reference fiber R are connected to the heat-transfer tube 3 between the first tube plate 11 and a first of the stabilizing elements 13 in a flow direction of the first fluid F1 through the heat-transfer tube 3.

FIG. 2 shows a schematic illustration of a design of a fiber-optic sensor 2 from FIG. 1, which fiber-optic sensor 2 is arranged on the respective heat-transfer tube 3. The fiber-optic sensor 2 comprises an optical coupler 19 that forms the coupling site in order to couple the measuring fiber M and reference fiber R to one another to create an interference signal. The optical coupler 19 comprises multiple, for example three, inputs and multiple, for example two, outputs. The electromagnetic emission source L is connected to one of the inputs and the measuring fiber M and the reference fiber R are respectively connected to one of the outputs, so that an electromagnetic wave produced using the electromagnetic emission source L is transmitted, in particular in a feed direction S, into the measuring fiber M as a measuring wave and into the reference fiber R as a reference wave. A detector PD is respectively connected to a plurality of the other inputs so that a measuring wave reflected back via the measuring fiber M and a reference wave reflected back via the reference fiber R can be detected as an interference signal at the other inputs using the respective detector PD. Normally, the inputs and outputs of the optical coupler 19 are connected to one another such that an electromagnetic wave conducted via one of the inputs is transmitted such that it is distributed to the outputs, and an electromagnetic wave conducted via one of the outputs is transmitted such that it is distributed to the inputs. In this manner, an interference signal corresponding to the elastic oscillation, in particular the natural frequency, of the heat-transfer tube 3 can be measuring using the detectors PD. The detectors PD are typically embodied as photodiodes. The detectors PD are typically connected to an electronic data acquisition unit 17 for the transfer of data, usually via electric data lines 10. The electronic data acquisition unit 17 can be connected to the electronic data collection unit 18 for the transfer of data. Between the electromagnetic emission source L and the optical coupler 19, an optical isolator 14 can be arranged in order to minimize back reflections of an electromagnetic wave fed to the optical coupler 19 using the electromagnetic emission source L. The electromagnetic emission L is typically electrically connected to an electrical control unit 15 for controlling the emission source L. Between the respective detector PD and the electronic data acquisition unit 17, an electrical amplifier 16, in particular a transimpedance amplifier, can be arranged in order to amplify an interference signal detected with the detector PD. At various of the heat-transfer tubes 3. a fiber-optic sensor 2 embodied in such a manner can respectively be arranged to determine a tube wall thickness of the respective heat-transfer tube 3.

FIG. 3 shows a graph that, by way of example, shows a relationship between a measured resonant frequency, or natural frequency, of an elastic oscillation of a heat-exchanger tube 3 and a tube wall thickness of a tube wall of the heat-exchanger tube 3. A linear relationship between the resonant frequency and tube wall thickness is illustrated by a straight fit curve. Multiple resonant frequencies or natural frequencies can be ascertained to determine the tube wall thickness.

FIG. 4 shows a schematic illustration of a further heat exchanger 1 with multiple fiber-optic sensors 2. The heat exchanger 1 can be embodied according to the explanations pertaining to the heat exchanger 1 from FIG. 1. In contrast to the fiber-optic sensors 2 of the heat exchanger 1 from FIG. 1, the fiber-optics sensors 2 according to FIG. 4 have a shared electromagnetic emission source L in the form of a laser. This is illustrated in FIG. 5. FIG. 5 shows a schematic illustration of fiber-optic sensors 2, arranged on different heat-transfer tubes 3, with a shared electromagnetic emission source L. The individual fiber-optic sensors 2 from FIG. 5 can be designed correspondingly to the fiber-optic sensor 2 from FIG. 2. In contrast to FIG. 2, the optical couplers 19 of the respective fiber-optic sensors 2 from FIG. 5 are coupled to the shared electromagnetic emission source L via an optical feed fiber, in order to feed an electromagnetic wave produced using the electromagnetic emission source L to the optical couplers 19 such that said wave split into the optical couplers 19. The feed fiber comprises a main branch and multiple side branches branching off from the main branch, in order to guide an electromagnetic wave conducted into the main branch using the electromagnetic emission source L to an input of the respective optical coupler 19 such that said wave is split into the side branches. Furthermore, the individual fiber-optic sensors 2 can have a shared electronic data acquisition unit 17 with which the detectors PD of the fiber-optic sensors 2 are connected for the transfer of data.

FIG. 6 shows a schematic illustration of a further fiber-optic sensor 2 which is arranged on a heat-transfer tube 3. The fiber-optic sensor 2 can be a fiber-optic sensor 2 of the heat exchanger 1 from FIG. 1 or can be embodied according to the features of the fiber-optic sensor 2 from FIG. 2. In contrast to the fiber-optic sensor 2 from FIG. 2, the fiber-optic sensor 2 from FIG. 6 has two electromagnetic emission sources L of a different wavelength and different coherence length of the electromagnetic waves thereof. For example, one of the electromagnetic emission sources L can be a laser with a laser light wavelength of 1300 nm and the other electromagnetic emission source L can be a laser with a laser light wavelength of 1550 nm. One of the lasers can have a coherence length between 0.5 mm and 10 mm, for example approximately 5 mm, and the other laser can have a coherence length between 10 μm and 500 μm, for example approximately 30 μm. The two electromagnetic emission sources L1, L2 are coupled to an optical coupling unit 20, typically respectively connected to an input line of the optical coupling unit 20, so that electromagnetic waves produced using the electromagnetic emission sources L are outputted on a shared optical output line of the optical coupling unit 20 in a superimposed manner. The output line of the optical coupling unit 20 is connected to an input of the optical coupler 19 for the transmission of the electromagnetic waves, in order to feed the electromagnetic waves to the measuring fiber M and reference fiber R via the optical coupler 19. Between the optical coupling unit 20 and the optical coupler 19, an optical isolator 14 can be arranged to minimize back reflections.

In this manner, superimposed measuring waves of a different wavelength and different coherence length can be used over the measuring fiber M or along the measurement section, and superimposed reference waves of a different wavelength and different coherence waves can be used over the reference fiber R or along the reference section. Accordingly, at the other inputs of the optical coupler 19, to which detectors PD are connected for the detection of interference signals, two superimposed interference signals occur for a detection using the detectors PD as a result of measuring waves reflected back along the measuring fiber M and reference waves reflected back along the reference fiber R. Between the detectors PD and the respective inputs of the optical coupler 19, one wavelength-selective demultiplexer DM each is arranged, in order to output the interference signals from electromagnetic waves of a different wavelength at different outputs of the demultiplexer DM. One detector PD each is connected to the outputs of the respective demultiplexer DM to measure the interference signal. In this manner, two different interference signals can be detected simultaneously. Due to the different coherence lengths, interference signals of a different shape occur. This enables a particularly accurate determination of the natural frequency or tube wall thickness. The detectors PD can be connected to a shared electronic data acquisition unit 17 for the transfer of data.

FIG. 7 shows a schematic illustration of a further heat exchanger 1 that is embodied as a stripper for stripping, wherein fiber-optic sensors 2 are arranged on multiple heat-transfer tubes 3 of the heat exchanger 1 to determine the tube wall thickness of the heat-transfer tubes 3. Typically, a heat exchanger 1 of this type is used for urea synthesis. The heat exchanger 1 can be embodied according to the explanations pertaining to the heat exchangers 1 and fiber-optic sensors 2 from FIG. 1 through FIG. 6 or can comprise corresponding fiber-optic sensors 2. The heat exchanger 1 is typically oriented such that a longitudinal extension of the heat-transfer tubes 3 is essentially vertically oriented. For urea synthesis, it is provided that the first fluid F1 is formed such that it comprises or is made of a first medium M1 and a second medium M2, wherein inside of the fluid chamber 4 or of the fluid chamber cavity 5, the first medium M1 and second medium M2 flow through the respective heat-transfer tube 3 in opposing flow directions. Normally, the first medium M1 is formed such that it comprises, in particular is made of, urea, ammonium carbamate, and ammonia, and the second medium M2 is formed such that it comprises, in particular is made of, gaseous carbon dioxide (CO₂). The heat exchanger 1 or stripper normally comprises a plurality, in particular more than 10, preferably more than 50, especially preferably more than 100, particularly preferably more than 1000, heat-transfer tubes 3. The heat exchanger 1 is typically oriented such that the first tube plate 11 is located above the second tube plate 12 in a vertical direction. Preferably, the respective fiber-optic sensor 2 is located between the first tube plate 11 and a first of the stabilizing elements 13.

The heat exchanger 1 comprises a first inlet 22, via which the first medium M1 can be fed into the heat-transfer tubes 3, and a second inlet 24, via which the second medium M2 can be fed into the heat-transfer tubes 3, so that inside of the fluid chamber 4 or the fluid chamber cavity 5, the media M1, M2 flow through the heat-transfer tubes 3 with opposing flow directions, in order to react with one another. In relation to the fluid chamber cavity 5, the first inlet 22 and the second inlet 24 are connected in a fluid-conducting manner to the heat-transfer tubes 3 at different ends of the heat-transfer tubes 3. For this purpose, the first inlet 22 and the second inlet 24 can respectively be connected in a fluid-conducting manner to a fluid distribution chamber, wherein ends of the heat-transfer tubes 3 are respectively connected in a fluid-conducting manner to the fluid distribution chamber, so that first medium M1 and second medium M2 fed into the respective fluid distribution chamber via the first inlet 22 and second inlet 24, respectively, are conducted into the heat-transfer tubes 3 such that they are distributed to the heat-transfer tubes 3. The heat exchanger 1 comprises a first outlet 23, via which a first product Z1 can be removed from the heat-transfer tubes 3, and a second outlet 25, via which a second product Z2 can be removed from the heat-transfer tubes 3, wherein in relation to the fluid chamber cavity 5, the first outlet 23 and second outlet 25 are connected in a fluid-conducting manner to the heat-transfer tubes 3 at different ends of the heat-transfer tubes 3, preferably in that the first outlet 23 and second outlet 25 are respectively connected in a fluid-conducting manner to one of the fluid distribution chambers, so that a first product Z1 and second product Z2 exiting the heat-transfer tubes 3 can be removed via the respective outlet 23, 25. The first product Z1 is typically urea. in particular in high purity. The second product Z2 is typically gaseous ammonia (NH₃) and/or gaseous carbon dioxide (CO₂). The second fluid F2 is normally formed such that it comprises, in particular is made of, liquid and/or gaseous water.

If, on one or more of the heat-transfer tubes 3 of the heat exchanger 1, a fiber-optic sensor 2 is respectively arranged which is embodied to interferometrically ascertain natural frequencies or resonant frequencies of an elastic oscillation of the respective heat-transfer tube 3 during operation of the heat exchanger 1, a tube thickness of the respective heat-transfer tube 3 can be practicably determined during operation of the heat exchanger 1. Preferably, the fiber-optic sensor 2 is designed such that the measuring fiber M and reference fiber R can be used, or can be arranged on the respective heat-transfer tube 3, at a working pressure of more than 30 bar, in particular between 30 bar and 200 bar, and/or a working temperature of more than 80° C., in particular between 80° C. and 300° C. This enables an optimized usability of the heat exchanger 1.

1. A heat exchanger, in particular a high-pressure heat exchanger for urea synthesis, comprising multiple heat-transfer tubes for transporting a first fluid in order to transfer heat between the first fluid and a second fluid via the heat-transfer tubes, wherein a fiber-optic sensor is respectively arranged on one or more of the heat-transfer tubes, wherein the fiber-optic sensor is designed to interferometrically ascertain an elastic oscillation, in particular a natural oscillation, of the respective heat-transfer tube during operation of the heat exchanger, in order to determine a tube wall thickness of the respective heat-transfer tube during operation of the heat exchanger.

2. The heat exchanger according to claim 1, wherein the fiber-optic sensor comprises an optical measuring fiber, which constitutes a measurement section, and an optical reference fiber, which constitutes a reference section, wherein the measuring fiber is connected in an oscillation-transferring manner to the heat-transfer tube, preferably wound around the heat-transfer tube. in order to detect an interference signal created with an electromagnetic wave guided along the measurement section and an electromagnetic wave guided along the reference section, using a detector of the fiber-optic sensor.

3. The heat exchanger according to claim 2, wherein the reference fiber is connected in an oscillation-decoupled manner to the heat-transfer tube, preferably wound around the heat-transfer tube.

4. The heat exchanger according to claim 2. wherein the heat exchanger comprises a fluid chamber for accommodating the second fluid, wherein the heat-transfer tubes run inside of the fluid chamber and the measuring fiber is connected in an oscillation-transferring manner to the heat-transfer tube inside of the fluid chamber, wherein a detector of the fiber-optic sensor is arranged outside of the fluid chamber for the detection of the interference signal.

5. The heat exchanger according to claim 2, wherein the fiber-optic sensor comprises an electromagnetic emission source, preferably a laser, for producing electromagnetic waves, wherein the emission source is coupled to the measuring fiber and the reference fiber in order to introduce electromagnetic waves into the measuring fiber and the reference fiber.

6. The heat exchanger according to claim 2, wherein the measuring fiber and the reference fiber respectively comprise a reflection element or connect to such a reflection element, in order to reflect an electromagnetic wave conducted along the measurement section and reference section using the reflection element.

7. The heat exchanger according to claim 2, wherein the measuring fiber and the reference fiber are coupled to one another at a coupling site in order to create an interference signal using an electromagnetic wave transmitted along the measurement section and an electromagnetic wave transmitted along the reference section.

8. The heat exchanger according to claim 2, wherein the fiber-optic sensor comprises an optical coupler having multiple input lines and multiple outlet lines, wherein the input lines and the output lines are connected to one another for the distributed transmission of electromagnetic waves, wherein the electromagnetic emission source is connected to one of the input lines and the measuring fiber and the reference fiber are respectively connected to one of the output lines, so that an electromagnetic wave introduced into the input line using the emission source is conducted into the measuring fiber and the reference fiber via the output lines.

9. The heat exchanger according to claim 8, wherein a detector, preferably formed such that it comprises a photodiode, is respectively connected to one or more of the input lines. in order to detect at the input lines, using the respective detector, an electromagnetic wave respectively reflected back into the output line along the measuring fiber and reference fiber, as an interference signal.

10. The heat exchanger according to claim 2, wherein the measuring fiber runs, at least in sections, through the second fluid during operation of the heat exchanger, wherein the fiber-optic sensor is designed such that the measuring fiber and the reference fiber can be used at a working pressure of more than 30 bar and/or a working temperature of more than 80° C.

11. The heat exchanger according to claim 2, wherein the measuring fiber and the reference fiber run, at least in sections, inside of a protective sheath, preferably formed such that it comprises metal or polyimide, for protection against an ambient pressure and/or an ambient temperature.

12. A method for operating a heat exchanger, in particular a heat exchanger according to claim 1, wherein, on one or more heat-transfer tubes with which a first fluid is transported in order to transfer heat between the first fluid and a second fluid via the heat-transfer tubes, a fiber-optic sensor is respectively arranged, wherein an elastic oscillation, in particular a natural oscillation, of the respective heat-transfer tube is interferometrically ascertained using the fiber-optic sensor during operation of the heat exchanger, in order to determine a tube wall thickness of the respective heat-transfer tube during operation of the heat exchanger.

13. The method according to claim 12, wherein the fiber-optic sensor comprises an optical measuring fiber, which constitutes a measurement section, and an optical reference fiber, which constitutes a reference section, wherein the measuring fiber is connected in an oscillation-transferring manner to the heat-transfer tube, wherein an elastic oscillation of the heat-transfer tube is ascertained by detection of an interference signal from an electromagnetic wave guided along the measurement section and an electromagnetic wave guided along the reference section.

14. The method according to claim 13, wherein the electromagnetic wave guided using the measuring fiber or reference fiber has a coherence length of more than 2 mm, in particular more than 5 mm.

15. The method according to claim 12, wherein second fluid typically has a pressure of more than 30 bar, in particular between 30 bar and 200 bar, preferably approximately 180 bar, and/or a temperature of more than 80° C., in particular between 80° C. and 300° C., preferably approximately 230° C.
